(19) United States
(12) Patent Application Publication
(10) Pub. No.: US 2020/0121965 A1
(43) Pub. Date: Apr. 23, 2020

(54) FLUID JET SYSTEM AND METHOD

(71) Applicant: PyroLance LLC, Ocala, FL (US)

(72) Inventors: Scott Alexander, Ocala, FL (US); Casparus Seyffert, Ocala, FL (US)

(21) Appl. No.: 16/657,799

(22) Filed: Oct. 18, 2019

Related U.S. Application Data
(60) Provisional application No. 62/747,606, filed on Oct. 18, 2018.
(60) Provisional application No. 62/800,288, filed on Feb. 1, 2019.
(60) Provisional application No. 62/893,641, filed on Aug. 29, 2019.

(51) Int. Cl. A62C 31/22; A62C 31/03

(52) U.S. Cl. CPC A62C 31/22; A62C 27/00; A62C 31/03

(57) ABSTRACT

A modular fluid jet attack system provides a system and method for both the containment of spreading flames and extinguishing a fire. A fluid jet system delivers high pressure fluids and abrasive materials to cut a hole in a wall. After the hole is cut, a firefighter can selectively stop the flow of abrasive material to provide fluid only for fire suppression using small droplets on the order of 150 microns. The fluid jet system can employ a gas system to tactically deliver a gaseous agent to aid in a military or law enforcement operation, or to deliver a gaseous agent for use in a firefighting operation, such as an electrical fire. Portions of the fluid jet system, the gas system and the attack system can be mounted in or on a vehicle, trolley, or case for portability.

### CROSS-REFERENCE TO RELATED APPLICATIONS

This application claims the benefit of and priority to U.S. Provisional Patent Application No. 62/747,606, filed Oct. 18, 2018, entitled “Fluid Jet System and Method”, and U.S. Provisional Patent Application No. 62/800,288, filed Feb. 1, 2019, entitled “Fluid Jet System and Method”, and U.S. Provisional Patent Application No. 62/893,641, filed Aug. 29, 2019, entitled “Fluid Jet System and Method”, the entire contents of which are incorporated herein by reference.

### BACKGROUND

Fluid jet systems have many applications, such as firefighting, surface cleaning, hydro-excavation, demolition, machining, mining, etc. Typical fluid jet systems provide a cutting or abrading function by projecting a jet of fluid at high velocity and pressure at a structure or surface. The specific fluid employed depends on the application. For example, for firefighting applications, a combination of fluid and an abrasive material may be employed to penetrate a wall or ceiling of a structure having a fire within, and upon creating a hole in the wall or ceiling, the abrasive material flow may be terminated while continuing the fluid flow through the hole to knock down the fire.

While existing fluid jet systems used in firefighting applications will knock down a fire, they generally cannot extinguish fires. When an existing fluid jet system is used to attack a fire, it is typically used for thermal layer control. More specifically, knocking down a fire means using the small droplets of fluid emitted by existing fluid jet systems to cool the layer of gas above the fire, interrupting the flame chain reaction of the combustion process. A fire attacked by existing fluid jet systems will generally continue to smolder until it redevelops in a free burning phase, or a voluminous amount of fluid is applied to the burning substance.

In order to apply the volume of fluid necessary to extinguish a fire via standard pressure firefighting techniques, specialized equipment is often required. Large, highly specialized trucks are necessary to transport fluid to the fire and/or pump fluid from nearby fluid sources. Standard attack line hoses used for application of fluid to the fire are long (typically 50 feet), bulky (varying in diameter from 1½ inches to 3 inches), and heavy, requiring multiple people for deployment and use. Further, most of the fluid applied to a fire using standard pressure firefighting techniques ends up as run-off.

Further, with respect to fluid droplet size, smaller fluid droplets fall to the ground more slowly than larger droplets. For example, fluid droplets with a diameter of 150 micron fall at approximately 0.6 meters per second, while a standard 500 micron diameter fluid droplet falls at approximately 2 meters per second. Because smaller fluid droplets fall more slowly, they can travel to the source of the heat using air currents of the fire space. When fluid is dispensed as droplets of approximately 150 microns in diameter, it may be referred to as a fluid mist.

The expansion of small fluid droplets can also help extinguish a fire. When small fluid droplets are exposed to heat and evaporate, the small fluid droplets expand approximately 5000-fold. This expansion displaces air (including oxygen) around a fire. Reducing oxygen levels around the fire to approximately 7% to 13% may extinguish a fire. Additionally, fluid mist helps block heat radiation by effectively absorbing and dispersing radiant heat given off by a fire. This reduces the feedback to the fuel surface of the fire and, in turn, reduces the pyrolysis rate. Additionally, use of fluid mist can provide a radiation shield to firefighters or other persons in contact with a fire.

There is often a need to provide rapid and effective firefighting capability that requires an agile response team with the ability to move quickly from location to location and/or in locations with minimal access. Thus, there exists a need for high-pressure fluid jet attack systems that can be mobile and/or modular for ease of transport and set-up in the field, while retaining the capabilities of much larger capacity systems.

### SUMMARY

Some embodiments described herein address at least some of the foregoing problems by providing a fluid jet attack system. In some embodiments, the fluid jet attack system includes a high-pressure fluid jet system having a non-pressurized lance barrel through which a high-pressure hose (“a lance hose”) is inserted and anchored at the distal end of the lance barrel, relative to an operator's position. In some embodiments, the other end of the lance hose is coupled to a high-pressure fluid source. According to some embodiments, the fluid can be fed into the lance hose and transported to the output of the lance barrel, where it is discharged as a fluid jet stream.

Some embodiments include a jet nozzle mounted at or near the distal end of the lance barrel, at the output of the lance hose, to control the characteristics of the fluid jet flowing out of the lance hose. In some embodiments, the jet nozzle is integral to the lance barrel and has a conventional coupling for the lance hose. In some embodiments, both the jet nozzle and the lance hose can be uncoupled and removed from the lance barrel. In some embodiments, fluid is discharged from the lance hose under high-pressure and through the nozzle to yield a fluid jet stream having droplets of appropriate size and velocity to effectively knock down a fire (i.e., cool the gas above the fire to prevent flames from spreading). In some embodiments, when infused with an abrasive material, in some embodiments the fluid jet exits the nozzle in a focused stream capable of cutting through most structural materials.

In some embodiments, the fluid jet attack system comprises a gas system configured and arranged to deliver a gaseous agent. In some embodiments, the gaseous agent can be a conventional firefighting gaseous agent (e.g., argon, CO2, and the like). In some embodiments, the gas system can be configured and arranged to deliver a dry powder agent for fighting class D fires, for example. In some embodiments, the dry powder agent is located in a container comprising a delivery gas. In some embodiments, the gas system comprises a separate gas source (e.g., a pressurized container or coupling) that mixes with the dry powder agent to deliver the power agent to a nozzle and/or increase the gas pressure at the nozzle. In some embodiments, the gas system can be employed by itself. In some embodiments, the gas system can be coupled to one or more nozzles to extinguish a specific class of fire where fluid is not desired (e.g., a class B or C fire). In some embodiments, gas system comprises a junction where it can be combined with a fluid jet and/or abrasives flow. In some embodiments, the gas system is a modular system comprising a gas container, a user operated valve, and one or more couplings for gas input and output. In some embodiments, the gas system can comprise a conventional operations gaseous agent, powder agent, and/or mixture thereof that is used in law enforcement or military operations (e.g., tear gas, pepper spray, and the like).

Some embodiments of the fluid jet attack system also include a high-pressure attack system that includes a high-pressure hose (“an attack hose”) coupled to a high-pressure fluid source. In some embodiments, the fluid jet attack system allows for selection of one or more of the fluid jet system, the attack system, and/or the gas system individually and/or simultaneously. For example, in some embodiments, once the fluid jet system is used to knock down the fire, the attack system is selected by an operator to efficiently apply fluid having droplets of appropriate size and velocity to extinguish the knocked down fire, or the gas system is selected to disable one or more hostile forces (e.g., a hostage situation).

### DESCRIPTION OF THE FIGURES

FIG. 1 illustrates an example of a fluid jet attack system in accordance with some embodiments of the invention.

FIG. 2 illustrates a hydraulic schematic of a fluid jet attack system in accordance with some embodiments of the invention.

FIG. 3 illustrates a plan view of a base station for a fluid jet attack system according to some embodiments.

FIG. 4 illustrates a right-side view of a base station for a fluid jet attack system according to some embodiments.

FIG. 5 illustrates a back view of a base station for a high-pressure attack system according to some embodiments.

FIG. 6 illustrates a front view of a base station for a fluid jet attack system according to some embodiments.

FIG. 7 illustrates a left-side view of a base station for a fluid jet attack system according to some embodiments.

FIG. 8 shows a fluid jet attack system controller architecture in accordance with some embodiments of the invention.

FIGS. 9A-9B show side perspective views of a fluid jet attack system mounted on a trolley and being supplied by a user in accordance with some embodiments of the invention.

FIG. 10 shows internal views of a fluid jet attack system mounted on a trolley in accordance with some embodiments of the invention.

FIGS. 11A-11C show a truck-mounted fluid jet attack system in accordance with some embodiments of the invention.

FIGS. 12A-12C show a portable portion of a modular fluid jet attack system according to some embodiments.

FIG. 13 shows a gas system in accordance with some embodiments.

### DETAILED DESCRIPTION

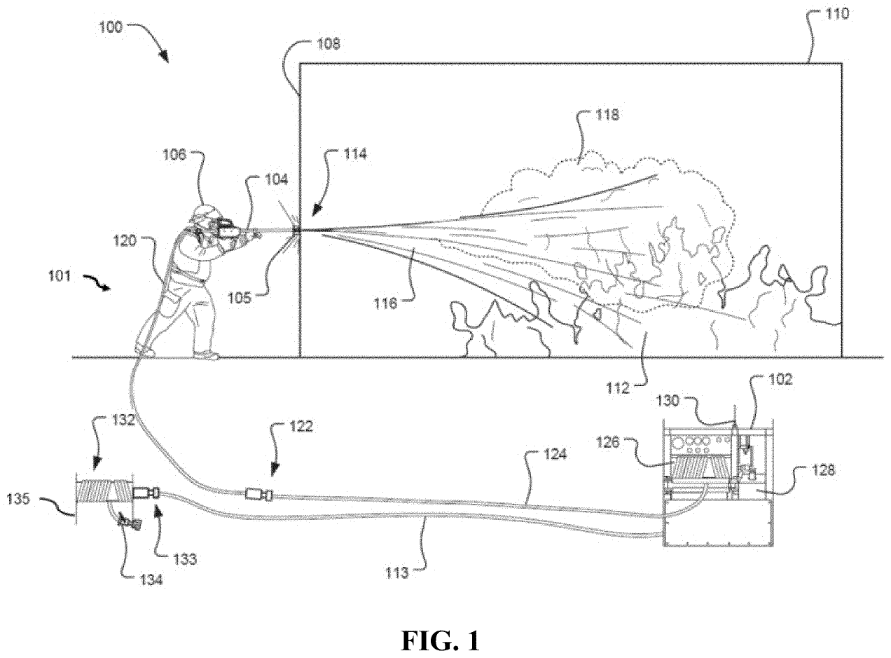

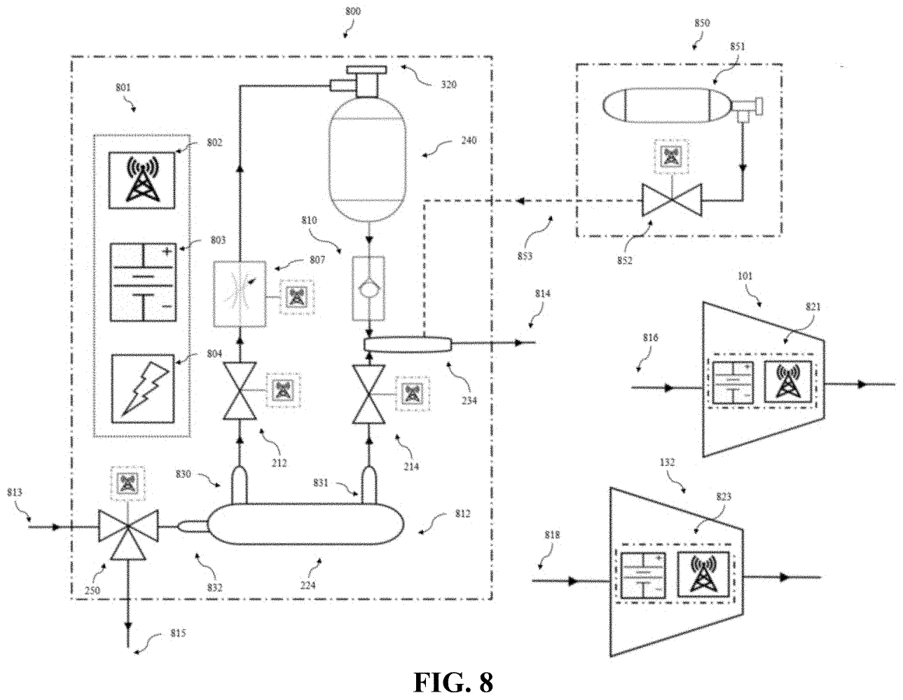

FIG. 1 illustrates an example of a fluid jet attack system 100 (also referred to herein as a/the “system”) used in a firefighting, law enforcement, and/or military application. In some embodiments, the fluid jet attack system 100 includes a high-pressure fluid jet system 101, a base station 102, and a high-pressure attack system 132. In some embodiments, fluid jet attack system 100 can be used to apply fluid to a fire 112. In some embodiments, example fluids can include, without limitation, non-flammable fluids (e.g., water); combinations of fluids and abrasive materials; combinations of fluids and fire suppressant foam; etc. In some embodiments, the specific fluid employed depends on the application. In some embodiments, a flow of fire retardant foam, gas, and/or material can be combined with the fluid flow to enhance the suppression of a fire (e.g., coating the fire's fuel to reduce its contact with oxygen). In some embodiments, the foam and or gas is delivered to one or more nozzles by one or more gas systems (the term “gas system” is a proper name referring a gas, foam, and/or powder container and valve configuration like gas system 850 shown in FIG. 8, with some embodiments comprising modifications as described herein).

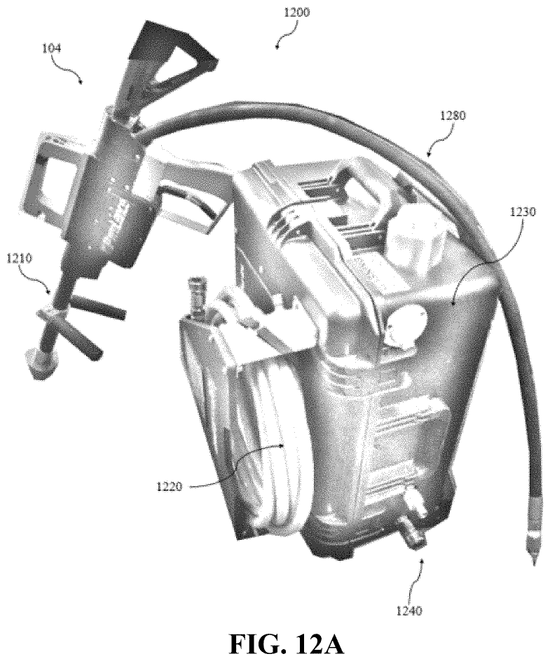

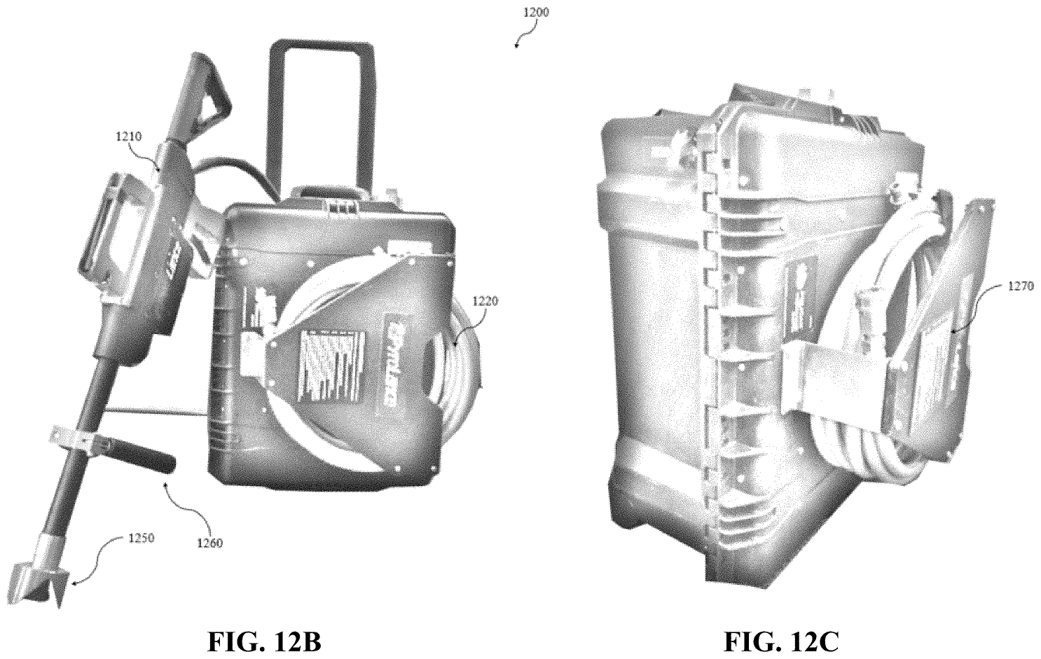

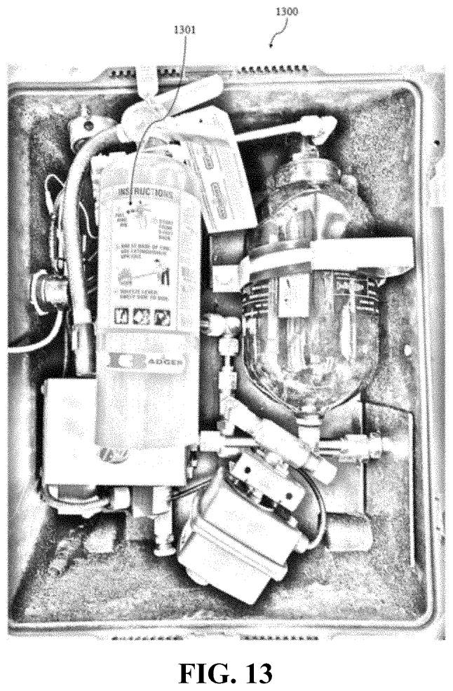

In FIG. 1, a firefighter 106 is shown holding the distal end of the lance 104 against a wall 108 (or door) of an enclosure 110 in which a fire 112 is burning according to some embodiments. In some embodiments, the lance 104 includes a substantially rigid lance barrel (see FIG. 12A: 1210) which contains a high-pressure lance hose 120 (1280) through which high-pressure fluid flows during operation. In some embodiments, the lance barrel 1210 allows the firefighter 106 to accurately direct the fluid flow and to steady the lance 104 against a surface, such as the wall 108. In some embodiments, the firefighter 106 initially cuts through the wall 108 using a combined flow of high-pressure fluid and abrasive material. In some embodiments, when the wall 108 is penetrated, the firefighter ceases the flow of abrasive material while continuing the flow of fluid, which streams into the enclosure 110 through the newly cut hole 114 in the wall 108 in a high-pressure jet 116 having small fluid droplets. In some embodiments, the fluid characteristics are such that fluid jet extends a considerable distance (e.g., over 40 feet) into the enclosure 110 and knocks down the fire 112 despite convection currents caused by the fire 112. In some embodiments, much of the fluid in the high-pressure jet 116 is vaporized (as shown by steam 118), reducing the intensity of the fire 112 and the temperature in the enclosure 110. In some embodiments, the high-pressure fluid jet system 101 knocks down the fire and makes it safer for firefighters to enter the enclosure 110 to progress their firefighting activities.

In preparation for applying the fluid jet system 100 to the fire 112 in the enclosure 110, in some embodiments, the firefighter 106 can take a steady stance; hold the lance 104 against his shoulder and with both hands (e.g., one hand in the trigger guard of the lance 104 and the other on a handle located forward of the trigger guard on the lance barrel); and place a placement structure at the distal end of the lance 104 against the wall 108. In some embodiments, the placement structure can be embodied by a 3-pronged offset fixture 105 with a splash plate to protect the operator from spray-back of fluid and debris during the cutting operation. In some embodiments, other placement structures may be employed to steady or aim the fluid jet at a target region of a structure. In some embodiments, the cutting performance of the fluid jet is improved when the placement structure allows the operator to “wiggle” the fluid jet about the target region. In some embodiments, the hole that is cut in the structure by the fluid jet develops a larger diameter than the fluid jet itself, thereby allowing fluid and debris to evacuate during the cutting operation.

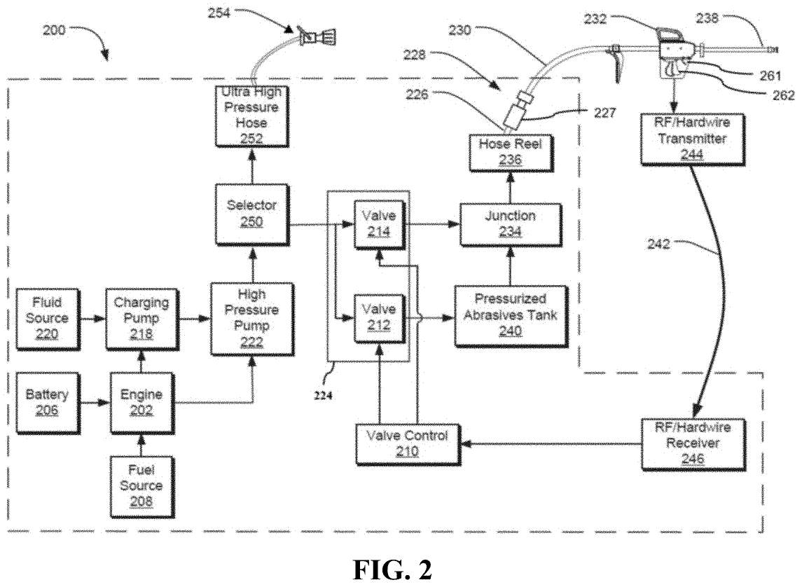

Best shown in FIG. 2, in some embodiments, the lance 104 includes two triggers 261, 262: 261 is a first trigger to control the flow of fluid from the base station 102 through the lance 104; and 262 is a second trigger to control the flow of abrasive material from an abrasives holding tank (i.e., container, vessel, etc.) in the jet base station 102 through the lance 104. In some embodiments, to commence the cutting stage the firefighter 106 pulls both triggers and a combined flow of fluid and abrasive material flows at high velocity against the wall 108, quickly cutting a small hole through the wall 108. In some embodiments, after the wall 108 is penetrated by the fluid/abrasive material combination, the firefighter 106 releases the abrasive material trigger and continues the flow of high-pressure fluid through the lance 104, through the hole in the wall 108, and into the enclosure 110 to knock down the fire 112. However, when it is unnecessary to cut a hole, the abrasive material need not be applied according to some embodiments. In some embodiments, one or more conventional buttons, levers, switches, dials, or any other mechanical, electrical, and/or digital actuator (e.g., a computer touch screen) can be used to start the flow of fluids and/or abrasives to the lance 104. In some embodiments, the lance hose 120 couples to the proximal end of the lance 104 a safe distance (e.g., one foot or more) away from the firefighter 106 to a high-pressure lance coupling 122, which couples the lance hose 120 to a high-pressure base hose 124 extending from the base station 102.

In some embodiments, the pressure of the discharge from the lance may vary between approximately 1500 pounds per square inch and 4400 pounds per square inch (psi). In some embodiments, this pressure may be selected by the user. It should be appreciated that pressure may vary based on flow rate and the physical constraints (hose diameter, nozzle diameter, etc.) of the system in some embodiments. For example, at 7 gallons per minute, fluid and/or material can be discharged from the lance at 1500 psi to 3500 psi according to some embodiments. In some embodiments, at 10 gallons per minute (gpm), fluid may be discharged from the lance at 1500 psi to 4000 psi. In some embodiments, at 15 gallons per minute, fluid may be discharged from the lance at 1500 psi to 4400 psi. In some embodiments, fluid can be discharged at any flowrate from 0 to 5000 psi and 0 to 30 gpm by adjusting various valve openings as would be understood by those of ordinary skill.

In some embodiments, once the intensity of the fire 112 is reduced (or knocked down), the firefighter 106 can at least partially extinguish the fire using the high-pressure attack system 132 to attack the fuel phase of the fire 112. In some embodiments, the high-pressure attack system 132 can be connected to base station 102 via a high-pressure coupling 133, which couples the high-pressure attack system 132 to high-pressure attack hose 113 connected to the base station 102. In some embodiments, fluid is dispensed from the high-pressure attack system 132 via an high-pressure attack nozzle 134. In some embodiments, the working pressure of the high-pressure attack system can vary between approximately 400 psi and 1400 psi. In some embodiments, the working pressure of the high-pressure attack line system may be selected and adjusted in real time by the user. In some embodiments, fluid can be discharged at any flowrate from 0 to 2000 psi by adjusting various valve openings as would be understood by those of ordinary skill.

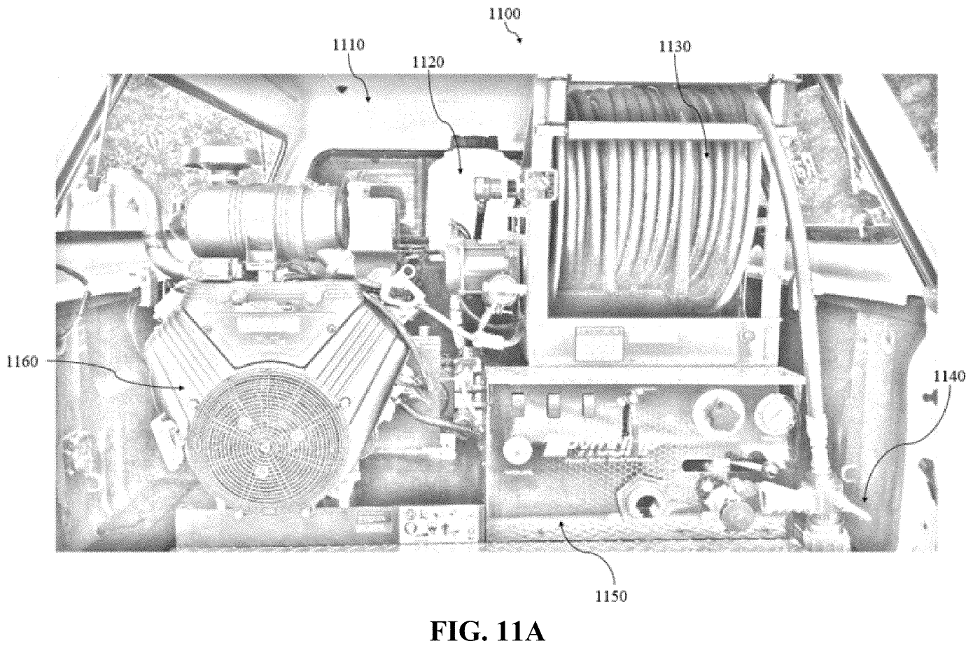

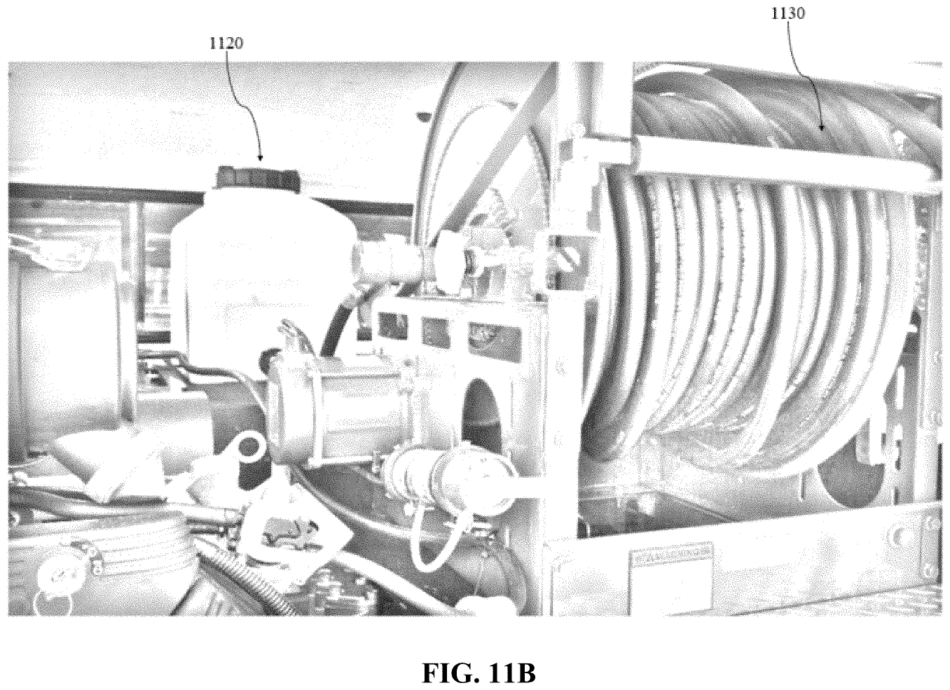

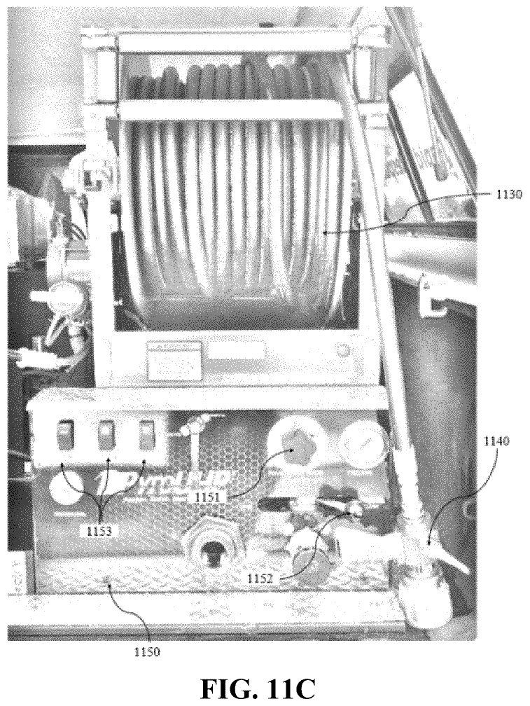

In some embodiments, the high-pressure attack hose 113 of the high-pressure attack system 132 is wound around a portable attack hose reel 135. In some embodiments, the attack hose reel 135 (or other hose container) can be incorporated into base station 102, and/or can be coupled to a vehicle (see FIG. 11A). In some embodiments, the attack hose 113 can be a smaller diameter (e.g., a ½ inch hose) than hoses used in conventional pressure firefighting techniques (e.g., 1 inch or greater). In some embodiments, a smaller diameter hose results in an increase in fluid pressure in the high-pressure attack system 132. In some embodiments, the high-pressure attack hose 113 is smaller in diameter and lighter than conventional pressure firefighting hoses. In some embodiments, the high-pressure attack hose 113 can be easier to maneuver, allowing for faster deployment as compared to conventional firehose deployments, particularly over long distances (e.g., distances over 25 feet). In some embodiments, the fluid jet attack system 100 can be operated by a single user.

In some embodiments, the high-pressure attack nozzle 134 can dispense fluid having small fluid droplet sizes (i.e., less than 300 microns {0.0118 in} in diameter; in some preferred embodiments, approximately 150 microns {0.0059 in} in diameter) and high velocity (e.g., greater than 22.4 m/s {50 mph}) as compared to conventional firefighting techniques. In some embodiments, the small fluid droplet size dispensed by the high-pressure attack nozzle 134 permits a fire 112 to be extinguished more efficiently than if it were extinguished via a conventional firefighting nozzle spraying a larger droplet size (i.e., greater than 300 microns). In some embodiments, the application of small fluid droplets to a fire at high-pressures increases the surface area for fluid heat absorption and allows a fire to be extinguished with less fluid than is necessary using conventional pressure firefighting techniques. For example, in some embodiments, at 1500 psi, the surface area available of a 7 gpm, flow of 150 micron diameter droplets is roughly equivalent to that of a 438 gallon per minute flow of larger fluid droplets. Thus, in some embodiments, the high-pressure attack system 132 allows for a fire to be extinguished when limited fluid is available, or when conventional firefighting apparatuses are unable to access the fire.

In some embodiments, the base station 102 includes a spring loaded and or motor driven automatically retracting base hose reel 126 that allows the high-pressure base hose 124 to be extended and retracted during operation and for storage. In some embodiments, the base station 102 also includes, among other components, a conventional power source (such as an electric or combustion engine), a fluid source (such as a tank or reservoir), an abrasives holding tank 128, a communications system (see FIG. 8: 801), multiple conventional valves with one or more conventional valve manifolds, a flow junction for combining multiple flows (e.g., a fluid jet flow and an abrasive material flow), a second high-pressure base hose 113 to connect the high-pressure attack system 132 to the base station 102.

FIG. 2 illustrates a hydraulic schematic of an example fluid jet attack system 200 according to some embodiments of the invention. In some embodiments, a pump engine 202 powers a charging pump 218 and a high-pressure pump 222. In some embodiments, the engine 202 is embodied by a single DEUTZ™ naturally aspirated 50 horsepower diesel engine, although other conventional engines or power sources may be employed, including gasoline engines, electric motors, hybrid engines, etc. In some embodiments, a battery 206 also provides power to a valve control circuit 210, valves 212 and 214 and a controller (see FIG. 8: 801) comprising a radio frequency (RF) or hardwire receiver 216. In some embodiments, engine 202 comprises a conventional alternator (not shown) that charges battery 206. In some embodiments, the charging pump 202 pulls fluid from a fluid source 220, such as a fluid tank, reservoir, and/or fluid supply line, and adds positive pressure to the system 100.

In some embodiments, the high-pressure pump 222 can be configured to discharge fluid at a pressure of approximately 2,200 PSI (149 bar) at a flow rate of 20 gallons per minute (GPM) (80 liters per minute) via a 1.2 inch outer diameter, 0.5 inch inner diameter high-pressure hose system (e.g., a base station hose 226, a coupling 227, a lance hose 230, and/or high-pressure attack hose 252 and high-pressure attack nozzle 254). In some embodiments, one or more of pressure, flowrate, component diameter and/or type of nozzle can be modified to bring about a desired result.

In some embodiments, when the selector 250 is set to operate the high-pressure fluid jet assembly 228, the high-pressure pump 222 can drive fluid at high-pressure (e.g., greater than 1000 psi) into the valves 212 and 214, which are set in a manifold 224. In some embodiments, the valves 212 and 214 are independently controlled by the valve controller 210, which can be signaled mechanically, electrically, or wirelessly from high-pressure fluid jet assembly 228.

In some embodiments, the valve 214 drives high-pressure fluid through the junction 234 and the hose reel 236 into the high-pressure fluid jet assembly 228, through the lance 232 and out a high-pressure jet nozzle 238. In some embodiments, valve 212 feeds into a pressurized abrasives holding tank 240, which contains abrasive material that improves the cutting performance of the fluid flow during a cutting stage of operation. In some embodiments, the pressurized abrasives holding tank 240 is a vessel mounted to the base station 204. In some embodiments, the vessel is a 2.5 gallon vessel. In some embodiments, the vessel is supplied with one or more abrasive materials. In some embodiments, abrasive materials comprise one or more of: PYROSHOT™ abrasive additive; inert, non-metallic materials; sand; diamond-cut granite; ground garnet; and the like. In some embodiments, any conventional abrasive materials or mixtures thereof designed for a fluid jet are used. In some embodiments, when the valve 212 drives pressurized fluid through the abrasives holding tank 240, a combination of fluid and abrasive material is driven to a junction 234, where it combines with the fluid flow from the valve 214. Accordingly, in some embodiments, when both valve 212 and valve 214 are open, a combination of abrasive material and fluid is driven out of the abrasives holding tank 240 and through the high-pressure assembly 228 and the lance 232 to the high-pressure nozzle 238 for application to the target surface, such as to cut through a structure or clean the target surface.

In some embodiments, a single manifold block 224 contains the valves 212 and 214 and regulates the pressure of the fluid flow output. In some embodiments, to achieve a desired mixture ratio, the individual outputs of each valve 212 and 214 are fed through individual channels of the manifold 224, wherein each manifold channel is configured and arranged to be adjustable to achieve the desired abrasive-to-fluid mixture ratio.

In some embodiments, the valves 212 and 214 can be controlled remotely from the lance 232 via a wireless (radio frequency (RF) or other frequency) communications link 242. In some embodiments, a transmitter 244 in (or communicatively coupled to) the lance 232 transmits signals to a receiver 246 in (or communicatively coupled to) the base station 204. In some embodiments, the lance 232 includes separate triggers 261, 262, to independently control the flows of fluid and abrasive material through the system 200. In some embodiments, abrasive material flow fed by the valve 212 is automatically restricted when no fluid flows through valve 214. In some embodiments, each trigger sends signals to the base station 204 to open or close the valves 212 and 214. In some embodiments, a firefighter closes both triggers to cut a hole in a structure using a high-pressure combination of fluid and abrasive material. In some embodiments, to execute the knock down operation on the fire, the firefighter closes only the trigger controlling valve 214, which provides only high-pressure fluid through the newly cut hole and into a burning room on the other side of the structure. In some embodiments, at least a portion of the components and configuration shown in FIG. 2 is applied to some or all embodiments disclosed herein.

In some embodiments, when the selector 250 configured and arranged to control delivery of fluid from the high-pressure pump 222 to one or both of the high-pressure fluid jet nozzle 238 and/or the high-pressure attack nozzle 238. In some embodiments, a firefighter can use the high-pressure attack nozzle 254 in a manner similar to conventional firefighting techniques.

In some embodiments, because both the high-pressure attack system 101 and the high-pressure attack line system 132 are under high-pressure when in use (e.g., greater than 1000 psi), it should be appreciated that conventional dump valves (not shown) can be used throughout the system 100 to relieve over-pressure as necessary. In some embodiments, the dump valves are used to drain the system 100 after use. Further, in some embodiments, conventional blow-off valves may be used as a safety feature in the system 100 to ensure that a maximum allowable pressure of the system is not exceeded.

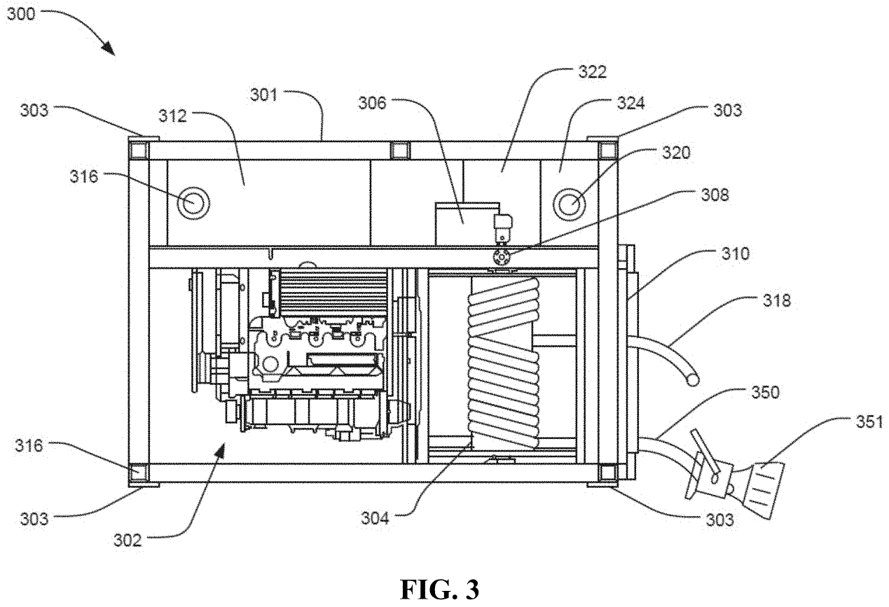

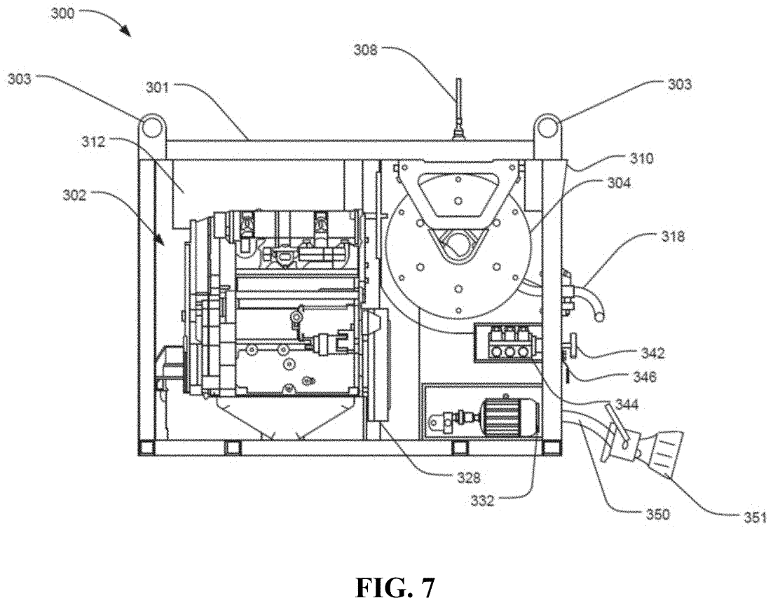

FIG. 3 illustrates a plan view of a base station 300 used in some embodiments of fluid jet attack system 100. In some embodiments, the base station 300 is generally housed within a rigid frame 301. In some embodiments, the frame 301 is formed piping and/or angle iron. In some embodiments, the self-contained base station 300 weighs approximately 100-500 pounds. In some embodiments, the base station 300 comprises cargo lifting connections 303 to aid in lifting and moving. In some embodiments, the base station 300 is powered by an engine 302 which drives a primer pump 322 and/or a high-pressure pump 332 (see FIG. 7), and provides power for an electric motor 306 (either by way of a conventional alternator and/or from recharging a connected battery such as one in battery box 314) which turns base hose reel 304 for feeding or winding of one or more hoses. In some embodiments, a fuel tank 312 comprising a fuel gauge 316 supplies fuel to the engine 302.

In some embodiments, the base station 300 includes a base hose reel 304, which allows or employs an automatic retraction of the base station hose 318 as the operator carries the lance 104. In some embodiments, the base station hose 318 is typically connected to a lance hose 120 via a high-pressure coupling 122. In some embodiments, a high-pressure attack hose 350 and attack nozzle 351 extends from the base station 300 as part of the high-pressure attack system 132.

In some embodiments, the base station 300 also includes a pressurized abrasive holding tank 326 that comprises anabrasives holding tank access 320 situated in holding tank compartments 322, 324. In some embodiments, the abrasive holding tank 326 stores abrasive material and feeds the abrasive material into the fluid flow during a cutting operation. In some embodiments, the high-pressure pump 332 drives fluid at a high-pressure into the abrasives holding tank 326 when the appropriate manifold valve is open. In some embodiments, cutting is merely an example application of the abrasive material flow. In some embodiments, other applications, such as surface cleaning, hydro-excavation, demolition, drilling, mining, military operations, law enforcement operations, can also employ by the system.

In some embodiments, the base station 300 comprises a radio antenna 308 for receiving signal inputs from a remote location as described in more detail later. In some embodiments, the system 100 comprises a pump control panel which displays operational parameters and controls various valves. In some embodiments, control panel is communicatively coupled to a conventional controller configured and arrange to receive input signals and execute programed instructions as further described below with reference to FIG. 8.

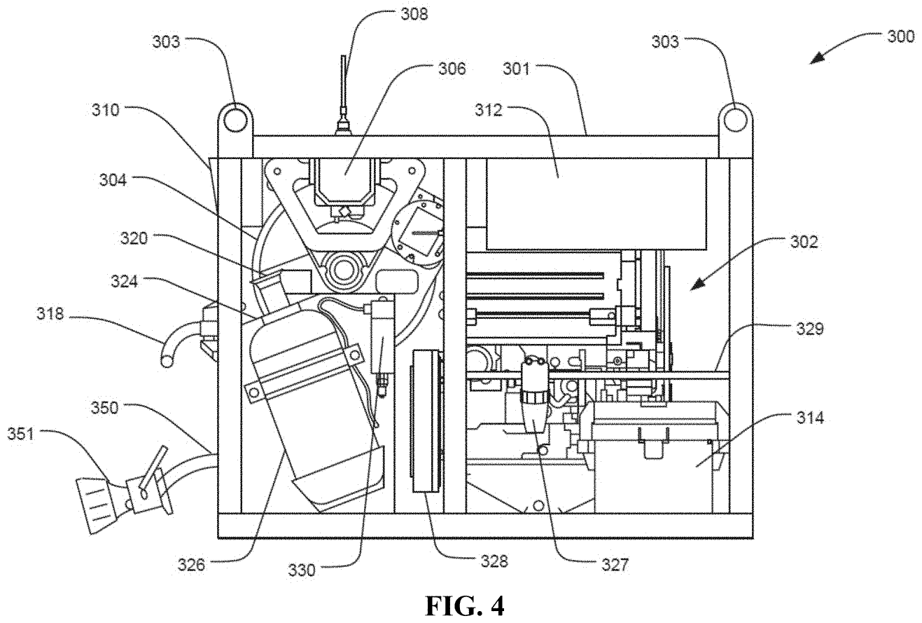

FIG. 4 illustrates a right-side view of a base station 300 for an example high-pressure attack system. In some embodiments, an abrasive holding tank 326 can be contained within an abrasive holding tank compartment 324. In some embodiments, two manifold valves 212, 214, and a shared manifold 330 are mounted within the abrasives holding tank compartment 324 to regulate the flows of fluid and abrasive material. In some embodiments, the inputs to the valves 212, 214, are controlled by the high-pressure pump 332 and the manifold 330. In some embodiments, the manifold 330 has an output for each valve 212, 214, one of which (212) feeds into the abrasives holding tank 326 and the other which (214) feeds into a junction 234 to combine with output flow from the abrasives holding tank 326. In some embodiments, a high-pressure attack hose 350 extends from the base station 300 to provide fluid flow from the high-pressure pump 222 to the attack nozzle 351 of the high-pressure attack system 132. In some embodiments, the base station 300 can comprise a flywheel 328 coupled to the engine 302 as well as a battery box 314.

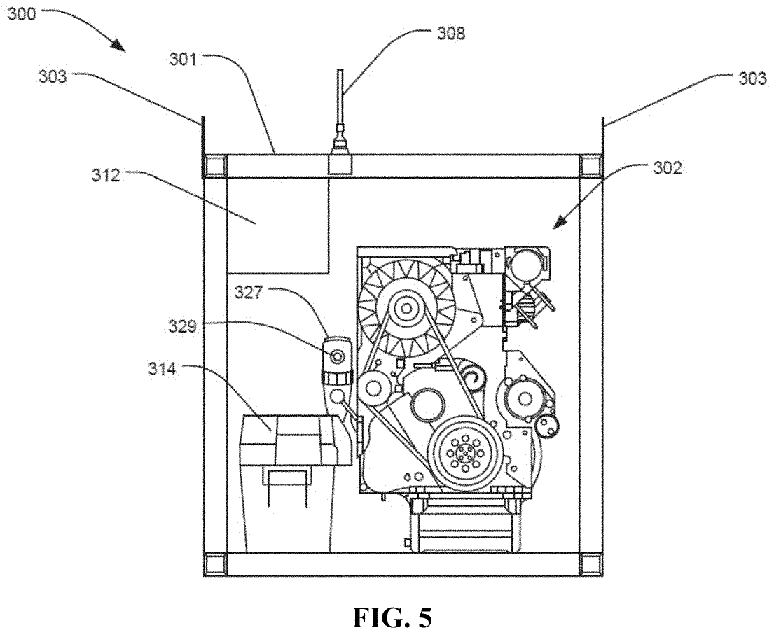

FIG. 5 illustrates a back view of base station 300 for a high-pressure attack system according to some embodiments. In some embodiments, the base station 300 can comprise one or more inline filters 327 that can remove impurities before exiting a discharge port 329. In some embodiments, various inline filters can be used to remove impurities from the system such as from the fluid jet fluid supply and the fuel supply, for example.

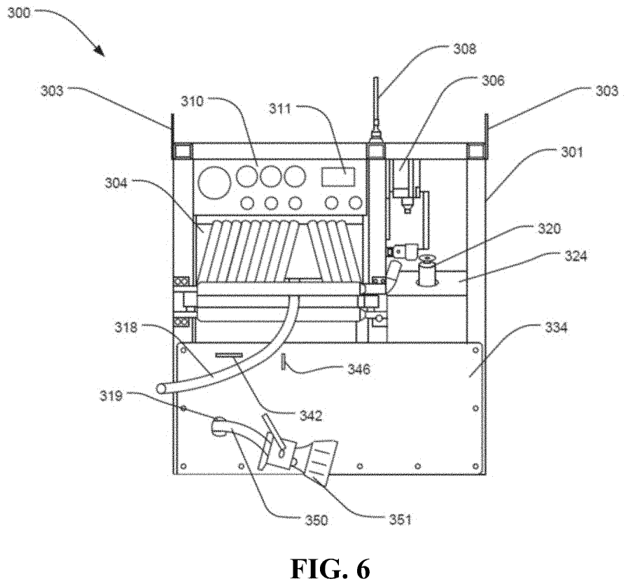

FIG. 6 depicts another perspective view of the base station 300 according to some embodiments. In some embodiments, the pump control panel 310 comprises a control valve override 311. In some embodiments, base station 300 comprises a pump enclosure panel 334 which comprises a hose outlet 319. In some embodiments, the base station 300 also comprises a pump primer valve 346 switch (e.g., a conventional knob, switch, button, or the like) as well as a pump priming lever 342.

FIG. 7 depicts another perspective view of the base station 300 according to some embodiments. In some embodiments, the base station further comprises a controller handle 344.

FIG. 8 depicts a valve controller arrangement 800 according to some embodiments. In some embodiments, the fluid jet attack system 100 comprises a controller 801. According to some embodiments, the controller 801 comprises a conventional computer (not shown), a signal processor 802, a battery 803 (e.g., 12V DC), and a battery charger 804. In some embodiments, the battery charger is one or more conventional power sources such as an alternator, a plug connection, a solar or wind generator, and the like. In some embodiments, the controller signal processor 802 is configured and arranged to transmit and/or receive signals to one or both of the fluid jet system 101 and/or the attack system 132. In some embodiments, the controller 210, receiver 246, and transmitter 244 shown in FIG. 2 are a part of or replaced with the controller arrangement shown in FIG. 8.

In some embodiments, the controller 801 is configured and arranged to control one or more valves. In some embodiments, the controller 801 comprises a computer that is configured and arranged to execute specified valve and pressure configurations in response to pre-programmed coded instructions. In some embodiments, the controller 801 is configured and arranged to execute specified valve and pressure configurations in response to manual signal inputs. In some embodiments, the controller 801 controls one or more of selector valve 250, abrasive feed valve 212, fluid jet supply valve 214, and or abrasives flow control valve 807. In some embodiments, abrasives flow control valve 807 is a variable flow control orifice. In some embodiments, the abrasive feed valve 212 and fluid jet supply valve 214 are KZCO′ feed and supply valves, respectively.

In some embodiments, the controller 801 configures selector valve 250 to deliver fluid from high-pressure pump 222 feed line 813 (as used herein, a “line” is a reference to a pipe, hose, or conventional fluid conduit) to high-pressure attack system 101 manifold 224 inlet 832. In some embodiments, controller 801 is configured and arranged to variably open abrasive feed valve 212 and/or flow control valve 807 such that high-pressure fluid flows into abrasives tank 240 (e.g., a one-gallon composite 3000 psi pressure vessel), through backflow prevention valve 810 (e.g., a check valve), to junction 234, where it is delivered by feed line 814 to the high-pressure fluid jet system 101 inlet 816. In some embodiments, controller 801 configures fluid jet supply valve 214 to be in an open, closed, or variably open state during fluid delivery to abrasives tank 240. In some embodiments, during fluid delivery to abrasive tank 240 fluid jet supply valve 214 is also delivering fluid to junction 234, where it is combined with the fluid/abrasives mixture coming from abrasives tank 240. In some embodiments, controller 801 closes one or both of feed valve 212 and flow control valve 807 to prevent the delivery of abrasives material to junction 234 while fluid jet supply valve 214 is in an open or variably opened state, so that only fluid is delivered to inlet 816 (e.g., at 10 gpm at 2200 psi).

In some embodiments, all valves can be manually operated. In some embodiments, controller 801 receives configuration signals from one or more signal inputs. In some embodiments, conventional knobs, levers, triggers, and/or buttons can be used as signal inputs to send signals to controller 801. In some embodiments, the controller 801 can be accept signals generated from a conventional display and/or graphical user interface (GUI. In some embodiments, the signal input can be located at or near the base station 102. In some embodiments, the signal input can be send from a computer (e.g., a desktop, laptop, personal digital assistant, cell phone, or the like) over a radio frequency (e.g., 2.4 GHz).

In some embodiments, the signal processor is wirelessly communicatively coupled with one or more nozzle signal processors 821 and 823. In some embodiments, the signal processor 801 is mechanically, fluidly, and/or electrically communicatively coupled to one or more nozzle signal processors 821, 823. In some embodiments, the signal inputs are sent from signal processors 821 and 823 located on the high-pressure attack system 101 and high-pressure attack system 132, respectively. In some embodiments, the systems 101 and 132 can comprise conventional knobs, levers, triggers, buttons and/or touchscreens that can be used as manual signal inputs to the nozzle signal processors which then relay the signal to the controller 801.

In some embodiments, controller 801 can configure selector valve 250 to direct fluid to feed line 815 which is coupled to inlet 818 of high-pressure attack system 132. As discussed above, in some embodiments high-pressure attack system 132 comprises nozzle signal processor 823, by which nozzle input signals can be sent to the controller 801 from a remote location to control one or more valves. In some embodiments, selector valve 250 can deliver fluid to both manifold 224 inlet 832 and attack feed line 815. In some embodiments, selector valve 250 is a series of valves in a manifold (e.g., similar to manifold 224), capable of selectively and/or variably sending fluid to multiple feed lines.

In some embodiments, the system 100 comprises a gas system 850. In some embodiments, the gas system comprises a gas container 851 and a gas valve 852. In some embodiments, the gas system is connected to the junction 234. In some embodiments, the gas system can be operated independent of the fluid jet system 101 and attack system 132. For example, once a hole 114 is cut (see FIG. 1) an operator can send a signal input to the controller 801 to configure system 100 to close one or more valve such that only gaseous agents are delivered via open gas valve 852 and feed line 853 according to some embodiments. In some embodiments, the controller 801 can configure the system 100 to deliver a gaseous agent to the junction 234 while a fluid and/or abrasive is also being delivered.

In some embodiments, the gas system is in a transport (e.g., a case, see FIG. 13) and can be connected anywhere in the system 100 where a coupling is available, such embodiments comprising a conventional selector valve and/or manifold with supporting conduit and couplings (not shown) that can provide a path through the gas system 850 for a fluid (e.i., a bypass), fluid gaseous agent mixture, or gaseous agent alone. In some embodiments, gaseous agents used in law enforcement operations and/or military operations can be employed. In some embodiments, once the hole 114 is cut, an operational agent can be deployed to disable one or more hostile forces. In some embodiments, the gas system 850 can be directly coupled to a nozzle, and can be used as a stand-alone fire extinguisher and/or operations tool.

In some embodiments, any of the illustrated or described components or assemblies, or any portion thereof, can be interchangeably mounted to a trolley, and/or mounted to a vehicle. In some embodiments, portions of the system 100 are modular, such that components can be relocated in groups to various supporting structures and locations. In some embodiments, all components of fluid jet system 100 are mounted to a trolley. In some embodiments, all components of fluid jet system 100 are mounted to a vehicle. In some embodiments, portions (e.g., hoses, nozzles, valves, couplings, signal processors) of the high-pressure attack system 101 and high-pressure attack system 132 are mounted to one or more trolleys and/or backpacks. In some embodiments, portions (e.g., one or more of high-pressure pump 222, charging pump 218, engine 202, battery 206, fluid source 220, fuel source 208, and/or selector valve 250, and/or one or more hoses) are mounted to a vehicle. In some embodiments, trolleys and/or backpacks are configured to be mounted to one or more vehicles and one or more components of the system 100 are separable in a modular fashion.

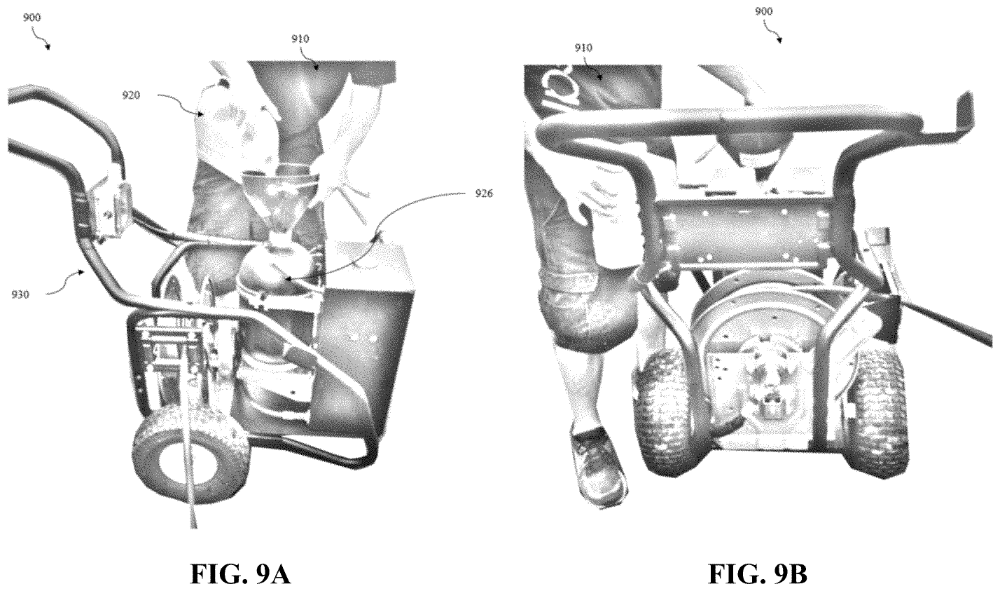

FIGS. 9A and 9B show side are rear perspective views of a trolley high-pressure fluid jet system 900. FIG. 9A shows some embodiments where a trolley 930 comprising a pressurized abrasives holding tank 926 is supplied with abrasives 920 by a user 910. In some embodiments, the components for the trolley high-pressure fluid jet system 900 comprise one or more components shown in FIG. 8. In some embodiments, the components for the trolley high-pressure fluid jet system 900 comprise one or more components as show in FIG. 2.

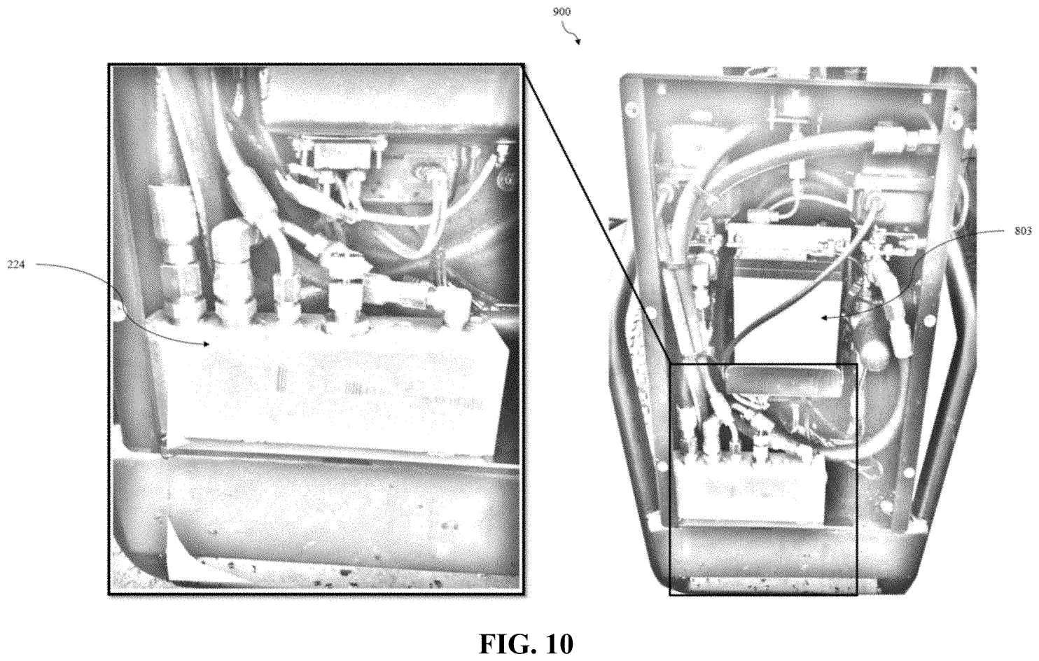

FIG. 10 shows internal views of a portion of the trolley high-pressure attack system 900 in accordance with some embodiments of the invention. In some embodiments, FIG. 10 shows details of the battery 803 and manifold 224.

FIG. 11A shows portions of a truck-mounted fluid jet attack system 1100 in accordance with some embodiments of the invention. In some embodiments, the truck-mounted fluid jet attack system 1100 comprises a vehicle 1110, a fluid supply source 1120, an high-pressure attack hose 1130, an high-pressure attack nozzle 1140, a controller 1150, and an engine 1160.

FIG. 11B shows a prospective view of truck-mounted fluid jet attack system 1100 according to some embodiments. In some embodiments, FIG. 11B shows further details of fluid supply source 1120 and high-pressure attack line hose 1130.

FIG. 11C shows another prospective view of truck-mounted fluid jet attack system 1100 according to some embodiments. In some embodiments, FIG. 11C shows some the various buttons 1153, knobs 1151, and levers 1152 associated with controller 1150.

FIGS. 12A-C show a portable fluid jet attack system 1200 in accordance with some embodiments. In some embodiments, trolley high-pressure attack system 900 and/or truck-mounted fluid jet attack system can comprise, couple to, or be used with one or more portable or mobile high-pressure fluid jet systems and/or high-pressure attack system s. In some embodiments, the attack systems nozzle 134 or lance 104 can each be exchanged and attached to a coupling (e.g., couplings 1240) for rapid and convenient conversion of an abrasives fluid jet system 101 to a attack system s 132 (and vice versa) in the field. In some embodiments, the portable attack system can facilitate use of the high-pressure fluid system 101 and high-pressure attack system 132 simultaneously through multiple couplings and supporting valve configuration, such as shown in FIG. 8, for example.

FIG. 12A shows a perspective view of the portable fluid jet attack system 1200 in accordance with some embodiments of the invention. FIG. 12A depicts a high-pressure attack system lance 1210; a case 1230, comprising one or more components shown in FIG. 8; couplings 1240 for one or more supply and/or delivery hoses; and a portable hose 1220. In some embodiments, the portable hose 1220 can be used for both lance 1210 and attack nozzle 1140.

FIG. 12B is a perspective view of the portable fluid jet attack system 1200 according to some embodiments. FIG. 12B shows further details of lance 1210 including offset fixture 1250 and handle 1260.

FIG. 12C is another perspective view of portable attack system 1200 according to some embodiments. FIG. 12C shows further details of the portable hose storage compartment 1270.

FIG. 13 shows a gas system 1300 constructed in accordance with some embodiments. In some embodiments, the gas system 1300 uses one of more gaseous agents to fight a fire and/or a hostile force. In some embodiments, gaseous agents comprise carbon dioxide and argon, for example. In some embodiments, gaseous agents comprise operations gasses such as tear gas, as a non-limiting example. In some embodiments, the gas system 1300 allows one or more conventional gaseous agents to be delivered through some of the embodiments described herein above. In some embodiments, the gas system is transportable and can be deployed without connecting it or coupling it to fluid jet system 101 or attack system 132. In some embodiments, the gas system 1300 comprises a removable conventional fire extinguisher 1301.

In some embodiments, advantages of gaseous agents can be low toxicity, low pressure, liquefied gas, and can be effective on all common types of fires. In some embodiments, gaseous agents do not form conductive ions. In some embodiments, conventional or novel gaseous agents can stop the spread of a fire by chemically disrupting combustion. In some embodiments, gaseous agents can be chemically stable compounds that can be recycled. In some embodiments, gaseous agents can extinguish fires without the production of residues. In some embodiments, gaseous agents can be used to disable one or more hostile forces.

In some embodiments, the portable fluid jet attack system 1200 can include a minimum flow requirement lance pressure of 1400 PSI {100 bar}. In some embodiments, the portable and modular attack system can include a flow rate of about 10 gpm {38 L/min}. Some embodiments can include higher or lower flow rates set by valve openings as desired by a user.

In some embodiments of the invention, the portable fluid jet attack system 1200 can deliver fluid with a fluid droplet size of about 0.0059″ (150 micron) or less. In some embodiments, the system 1200 can deliver fluid or other fluids with smaller or larger droplet sizes.

In some embodiments of the invention, the portable fluid jet attack system 1200 can include a fluid velocity of about 150 mph (240 km/h). In some embodiments, the fluid velocity can be any value between 0 and 200 mph (322 km/h).

In some embodiments, the portable fluid jet attack system 1200 can include a fluid delivery distance of about 80 feet (25 meters). In some other embodiments, the fluid delivery distance can be and value between 0 and 200 feet (61 meters).

In some further embodiments of the invention, the portable fluid jet attack system 1200 can comprise a module size of about 21″×17″×24″ (533×432×610 mm). In other embodiments, the module size can be larger or smaller depending on one or more of the operating parameters and/or coupled or associated peripherals and accessories.

In some embodiments, the portable fluid jet attack system 1200 can comprise a weight of about 100 pounds (45 kg). In other embodiments, the weight can be higher or lower depending on one or more of the operating parameters and/or coupled with associated peripherals and accessories.

In some embodiments, the portable fluid jet attack system 1200 can include a component failure safety margin of 2:1. In some preferred embodiments, the portable attack system can include a component failure safety margin of 4:1.

Some embodiments include a hose comprising a ½″ diameter hose, with a length of 10 to 100 feet (3.048 to 30.048 meters). Some embodiments can include alternate supply hose lengths. In some embodiments, the fluid jet attack system 100 can include hose lengths between 1 to 1000 feet (0.3048 to 304.8 meters).

In some embodiments, the portable and modular attack system can include at least one control system controlled by a controller, such as shown in FIG. 8, for example. In some embodiments, portable fluid jet attack system 1200 can include at least one wireless system for control and/or relay of operational parameters. In some embodiments, any of the wireless and/or control systems components described herein can be included in the portable attack system.

In some embodiments, the portable and modular attack system can include an abrasives delivery capability. For example, in some embodiments, the portable and modular attack system can include an abrasive storage vessel. For example, in some embodiments, the portable and modular attack system can include a one-gallon (3.8 L) abrasive vessel. In some further embodiments, the abrasive and/or an abrasive storage vessel can be any of those described herein. In some embodiments, the portable fluid jet attack system 1200 can comprise at least a portion of the abrasives delivery configuration shown in FIG. 2 and FIG. 8.

The previous detailed description is to be read with reference to the figures, in which like elements in different figures have like reference numerals and/or like reference names. The figures, which are not necessarily to scale, depict some embodiments and are not intended to limit the scope of embodiments of the system.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. In addition, “substantially” and “approximately” can include a difference of 10% or less of the same unit and scale of that being measured. In a preferred embodiment, “substantially” and “approximately” can include a difference of 5% or less.

References to a “high-pressure” structure within the disclosure are to be considered as part of a proper name for the structure and is not intended to limit the structure to embodiments where high pressures are used in combination with the system: a “high-pressure” structure is capable of being used in both high-pressure (e.g., greater or equal to than 1000 psi) and low-pressure (e.g., less than 1000 psi) embodiments as is understood by those of ordinary skill. Applicant reserves the right to use “high-pressure” in the claims as part of a proper name acting as their own lexicographer. Likewise, the term “transport” is defined herein as a proper noun for any structure that allows for one or more objects to be moved simultaneously as a group, and “gaseous agent” is a proper noun for any chemical that can be delivered by a gas.

Some embodiments of the system are presented with specific values and/or setpoints. These values and setpoints are not intended to be limiting, and are merely examples of a higher configuration versus a lower configuration and are intended as an aid for those of ordinary skill to make and use the system. Embodiments of each valve configuration can fall within any value range specific to a user application as would be recognized by those of ordinary skill.

It is understood that the system is not limited in its application to the details of construction and the arrangement of components set forth in the previous description or illustrated in the drawings. The system and methods disclosed herein fall within the scope of numerous embodiments. For example, in some embodiments, the system can be employed in other applications, including, but not limited to, surface cleaning, hydro-excavation, demolition, machining, mining, etc. The previous discussion is presented to enable a person skilled in the art to make and use embodiments of the system. Modifications to the illustrated embodiments and the generic principles herein can be applied to all embodiments and applications without departing from embodiments of the system. Also, it is understood that features from different embodiments presented herein can be combined to form new embodiments that fall within the disclosure. Thus, embodiments of the system are not intended to be limited to embodiments shown, but are to be accorded the widest scope consistent with the principles and features disclosed herein.

1. A high-pressure fluid jet attack system comprising:
a high-pressure fluid jet system comprising a fluid jet nozzle;
a high-pressure attack system comprising an attack nozzle;
at least one hose; and
a base station comprising:
a selector valve;
an abrasives tank;
an abrasives-jet junction;
an abrasives tank conduit;
a jet nozzle fluid conduit;
an attack nozzle fluid conduit; and
an abrasives-jet mixture conduit;
wherein the selector valve is configured and arranged to deliver fluid to one or more of the abrasives tank conduit, the jet nozzle fluid conduit, and/or the attack nozzle fluid conduit;
wherein the abrasives tank is configured and arranged to deliver an abrasives-fluid mixture to the abrasives jet junction;
wherein the jet nozzle conduit is configured and arranged to deliver fluid to the abrasives-jet junction; and
wherein the base station is configured and arranged to selectively deliver:
at least a portion of the fluid from the jet nozzle conduit to the abrasives-jet junction alone, or
at least of portion of both the fluid from the jet nozzle conduit and the abrasives-fluid mixture to the abrasives jet junction simultaneously.

2. The high-pressure fluid jet attack system of claim 1,
further comprising a controller,
wherein the controller is configured an arranged to control the actuation and configuration of the selector valve upon receiving an input signal from a user.

3. The high-pressure fluid jet attack system of claim 1,
wherein the high-pressure fluid jet attack system is configured and arranged to generate fluid pressures greater than or equal to 1000 psi.

4. The high-pressure fluid jet attack system of claim 2,
wherein the controller further comprises a controller signal processor;
wherein the input signal is a wireless input signal; and
wherein fluid jet attack system is configured and arranged to send the wireless input signal from a remote signal processor that is physically decoupled from the controller.

5. The high-pressure fluid jet attack system of claim 3,
wherein the high-pressure fluid jet system further comprises a fluid jet signal processor;
wherein the high-pressure attack system further comprises a fire attack signal processor; and
wherein the wireless input signal is transmitted from one of the fluid jet and/or fire attack signal processors.

6. The high-pressure fluid jet attack system of claim 5,
wherein the high-pressure fluid jet attack system is configured and arranged to generate fluid pressures greater than or equal to 1000 psi.

7. A modular high-pressure fluid jet attack system comprising:
a high-pressure fluid jet system comprising a fluid jet nozzle;
a high-pressure attack system comprising an attack nozzle;
a base station comprising:
a selector valve;
an abrasives tank;
an abrasives-jet junction;
an abrasives tank conduit;
a jet nozzle fluid conduit;
an attack nozzle fluid conduit; and
an abrasives-jet mixture conduit;
a pump system comprising at least one pump;
at least one hose; and
at least one trolley;
wherein the selector valve is configured and arranged to deliver fluid to one or more of the abrasives tank conduit, the jet nozzle fluid conduit, and/or the attack nozzle fluid conduit;
wherein the abrasives tank is configured and arranged to deliver an abrasives-fluid mixture to the abrasives jet junction;
wherein the jet nozzle conduit is configured and arranged to deliver fluid to the abrasives-jet junction;
wherein the base station is configured and arranged to selectively deliver:
at least a portion of the fluid from the jet nozzle conduit to the abrasives-jet junction alone, or
at least of portion of both the fluid from the jet nozzle conduit and the abrasives-fluid mixture to the abrasives jet junction simultaneously.

8. The modular high-pressure fluid jet attack system of claim 7,
wherein the at least one trolley comprises at least one of the high-pressure fluid jet system and/or the high-pressure attack system; and
wherein the at least one trolley does not comprise the pump system.

9. The modular high-pressure fluid jet attack system of claim 7,
wherein the at least one trolley comprises a fluid jet trolley comprising the high-pressure fluid jet system.

10. The modular high-pressure fluid jet attack system of claim 9,
wherein the at least one trolley further comprises a fire attack trolley comprising the high-pressure attack system and/or the high-pressure fluid jet system.

11. The modular high-pressure fluid jet attack system of claim 10,
further comprising a gas system comprising a gaseous agent;
wherein the gas system is coupled to the abrasives jet junction;
wherein the high-pressure fluid jet attack system is configured and arranged to supply gaseous agent either alone, or in combination with the fluid and/or the abrasives-fluid mixture.

12. The modular high-pressure fluid jet attack system of claim 11,
wherein the at least one trolley does not comprise the pump system.

13. A portable high-pressure fluid jet attack system comprising:
a high-pressure fluid jet system comprising a fluid jet nozzle;
a high-pressure attack system comprising an attack nozzle;
a base station comprising:
a selector valve;
an abrasives tank;
an abrasives-jet junction;
an abrasives tank conduit;
a jet nozzle fluid conduit;
an attack nozzle fluid conduit; and
an abrasives-jet mixture conduit;
a pump system comprising at least one pump;
at least one hose; and
at least one transport;
wherein the selector valve is configured and arranged to deliver fluid to one or more of the abrasives tank conduit, the jet nozzle fluid conduit, and/or the attack nozzle fluid conduit;
wherein the abrasives tank is configured and arranged to deliver an abrasives-fluid mixture to the abrasives jet junction;
wherein the jet nozzle conduit is configured and arranged to deliver fluid to the abrasives-jet junction; and
wherein the base station is configured and arranged to selectively deliver:
at least a portion of the fluid from the jet nozzle conduit to the abrasives-jet junction alone, or
at least of portion of both the fluid from the jet nozzle conduit and the abrasives-fluid mixture to the abrasives jet junction simultaneously.

14. The portable high-pressure fluid jet attack system of claim 13,
wherein the at least one transport is at least one vehicle comprising a motor; wherein the at least one vehicle comprises the high-pressure fluid jet system, the high-pressure attack system, the base station, and the pump system.

15. The portable high-pressure fluid jet attack system of claim 13,
wherein the at least one transport comprises at least one carrying case.

16. The portable high-pressure fluid jet attack system of claim 15,
wherein the at least one carrying case is a fluid jet carrying case;
wherein the high-pressure fluid jet system comprises the base station; and
wherein the fluid jet carrying case comprises the high-pressure fluid jet system.

17. The portable high-pressure fluid jet attack system of claim 16,
wherein the high-pressure fluid jet system is configured and arranged to sustain fluid pressures greater than or equal to 1000 psi.

18. The portable high-pressure fluid jet attack system of claim 16,
further comprising a controller comprising a controller signal processor,
wherein the high-pressure fluid jet system further comprises a fluid jet signal processor; and
wherein the controller is configured an arranged to control the actuation and configuration of the selector valve upon receiving an input signal from the fluid jet signal processor.

19. The portable high-pressure fluid jet attack system of claim 17, wherein the at least one transport further comprises a vehicle;
wherein the vehicle is configured and arranged to transport the high-pressure attack system, the pump system, and the fluid jet carrying case.

20. The portable high-pressure fluid jet attack system of claim 19,
wherein the at least one transport further comprises a trolley;
wherein the trolley comprises the high-pressure attack system; and
wherein the trolley and the carrying case are each modular and separable from the vehicle.
